(19) United States
(12) Patent Application Publication
(10) Pub. No.: US 2004/0071115 A1
(43) Pub. Date: Apr. 15, 2004

(54) Intelligent uplink SCDMA scheduling incorporating polarization and/or spatial information to determine SCDMA code set assignment

(76) Inventors: Mark Earnshaw, Nepean (CA); David Damian Nicholas Bevan, Hertfordshire (GB); Bassam Hashem, Ottawa (CA); Julius G. Robson, Dunmow (GB)

Correspondence Address: Dennis R. Haszko, Shapiro Cohen, Station D, P.O. Box 3440, Ottawa, ON, K1P 6P1, CA

(21) Appl. No.: 10/268,906

(22) Filed: Oct. 11, 2002

(51) Int. Cl. H04B 7/216

(52) U.S. Cl. 370/335

(57) ABSTRACT

A method for synchronous code division multiple access (SCDMA) scheduling including intelligent uplink SCDMA scheduling that incorporates polarization and/or spatial information to determine SCDMA code set assignment. The method includes scheduling algorithms to reduce observed interference and thus allow for a potentially significant increase in uplink capacity. This allows more terminals to be accommodated within a single site (i.e., higher sustainable user density) and/or a reduction in the number of base stations that must be deployed in order to cover a given area. This present invention is applicable to any high-speed wireless evolution SCDMA-based data system that would require highly efficient and optimized scheduling algorithms.

### BACKGROUND OF THE INVENTION

1. Field of the Invention

The present invention relates to any product using synchronous code division multiple access (SCDMA) for the uplink of a wireless communication system. More specifically, the present invention pertains to intelligent uplink SCDMA scheduling that incorporates polarization and/or spatial information to determine SCDMA code set assignment.

2. Description of the Prior Art

CDMA-based uplink connections are included in third-generation (3G) and proposed 3G-evolution wireless systems. 3G wireless designs include the Third Generation Partnership Project (3GPP) and the Third Generation Partnership Project 2 (3GPP2).

3GPP is a collaboration agreement that was established in December 1998. The collaboration agreement brings together a number of telecommunications standards bodies. The original scope of 3GPP was to produce globally applicable Technical Specifications and Technical Reports for a 3rd Generation Mobile System based on evolved Global System for Mobile communication (GSM) core networks and the radio access technologies that they support (i.e., Universal Terrestrial Radio Access (UTRA) both Frequency Division Duplex (FDD) and Time Division Duplex (TDD) modes). The scope was subsequently amended to include the maintenance and development of the GSM Technical Specifications and Technical Reports including evolved radio access technologies (e.g., General Packet Radio Service (GPRS) and Enhanced Data rates for GSM Evolution (EDGE)).

3GPP2 is a collaborative third generation (3G) telecommunications standards-setting project comprising North American and Asian interests developing global specifications for American National Standards Institute/Telecommunications Industry Association/Electronic Industries Alliance (ANSI/TIA/EIA)-41 “Cellular Radio-telecommunication Intersystem Operations network evolution to 3G, and global specifications for the radio transmission technologies (RTTs) supported by ANSI/TIA/EIA-41.

3GPP2 was born out of the International Telecommunication Union's (ITU) International Mobile Telecommunications “IMT-2000” initiative, covering high speed, broadband, and Internet Protocol (IP)-based mobile systems featuring network-to-network interconnection, feature/service transparency, global roaming and seamless services independent of location. IMT-2000 is intended to bring high-quality mobile multimedia telecommunications to a worldwide mass market by achieving the goals of increasing the speed and ease of wireless communications, responding to the problems faced by the increased demand to pass data via telecommunications, and providing “anytime, anywhere” services.

The use of CDMA facilitates designing a many-to-one (many terminals to one base station) multiple access communications scheme because any other users transmitting at the same time simply appear as interference to a desired user's signal. CDMA systems are essentially interference limited. Once the observed interference level reaches a certain threshold, the capacity of the system has been reached and no further terminals may be admitted unless overall system performance is degraded for the existing active terminals. As a result, any increase in capacity is obtained only by reducing the visible interference relative to each user's signal. Various known methods exist for accomplishing this. Three such methods for reducing interference include the orthogonal separation of signals via synchronous CDMA (SCDMA), the use of differing signal polarizations between terminals, and the spatial separation of signals using directional antennas and/or antenna beam-forming.

SCDMA relies on assigning OVSF (Orthogonal Variable-Length Spreading Factor) codes to individual users. These spreading codes are mutually orthogonal and when transmissions are time-synchronized between simultaneously transmitting terminals, mutual interference can be reduced significantly. However, the number of OVSF codes within one SCDMA code set is limited, and this can restrict the maximum aggregate amount of data that can be transmitted over the uplink by active terminals, assuming that only one SCDMA code set is used. However, the assignment of an outer pseudo-noise (PN) scrambling code to all of the terminals within the same SCDMA code set allows additional SCDMA code sets to be defined with different PN scrambling codes. Users within the same SCDMA code set will be orthogonal to each other (i.e., minimal mutual interference), but will appear as normal asynchronous CDMA (ACDMA) interference to users from another SCDMA code set.

Both 3GPP and 3GPP2 propose the possible use of SCDMA on their uplinks to reduce interference by assigning synchronized orthogonal spreading codes to simultaneously active terminals. The resulting decrease in mutual interference yields a corresponding increase in uplink capacity. In packet-based wireless communications systems, the available uplink transmission resources (e.g., orthogonal spreading codes) are shared among all of the active users. This resource allocation process is under the control of an uplink scheduler located at the base station. An intelligent scheduling of the available uplink transmission resources taking into consideration other interference reduction techniques such as spatial separation and polarization grouping could yield a significant increase in uplink capacity as compared to a “random” scheduling assignment.

Spatial separation via an antenna array is one of the most popular forms of space diversity. Systems designed to receive spatially propagating signals can exploit the spatial separation of desired signals and interference to build a spatial filter at the receiver. Directional antennas can be used to spatially separate the propagating signals. Alternatively, beam forming can be used. Beam forming is the combining of radio signals from a set of non-directional antennas to simulate one antenna with directional properties. Usually, the array signals are combined in such a way that a particular direction is emphasized and noise and interference from other directions are rejected.

Polarization grouping is a term that often arises in the literature and when considering radio frequency communication. The polarization of a propagating wave is determined by the locus or path described by the electric field vector with respect to time. If we ascribe an x, y, z co-ordinate system to a propagating wave, with the direction of propagation being in the z direction, the electric field vector, E will be in the x, y plane. If E remains in the same orientation with respect to time, so that its locus describes a straight line, the wave is accordingly linearly polarized. However, if the locus describes a circular motion with respect to time the wave is accordingly circularly polarized. Where the locus describes an elliptical path the wave is accordingly elliptically polarized. Circular polarization is often used in communication systems since the orientation of the transmitting and receiving antenna is less important than it is with linearly polarized waves. Grouping of polarizations along a specific direction (e.g., horizontal) of propagation within a cell provides for reuse of orthogonal spreading codes in other groupings of polarizations along a differing direction (e.g., vertical) of propagation with that cell.

As mentioned, SCDMA is currently being considered within various 3G evolution wireless standards bodies (e.g., 3GPP, 3GPP2) for use on the uplink of future wireless communication systems due to its potential for significantly reducing interference within any given cell—i.e., intra-cell interference. However, an inherent problem is that each SCDMA code set has a limitation on the number of users that can be accommodated due to the finite number of orthogonal codes within each SCDMA code set. Increasing the number of users beyond this limit requires the allocation of additional SCDMA code sets. This presents a difficulty such that doing so will result in additional interference unless the additional SCDMA code sets are used in conjunction with other interference reduction techniques. It is important to note that different SCDMA code sets are not mutually orthogonal, whereas spreading codes within the same SCDMA code set are orthogonal.

What is needed therefore is a scheduling algorithm that offers a simple, yet effective, method for further increasing the potential capacity of a cell through the intelligent assignment of SCDMA code sets and orthogonal codes used for interference separation in conjunction with other mutual interference reduction techniques such as signal polarization grouping, and spatial separation via directional antennas or beam-forming. It should be readily understood that any wireless system incorporating an SCDMA uplink can benefit from such a scheduling technique.

### SUMMARY OF THE INVENTION

The present invention provides a method for further increasing the potential capacity of a cell through the intelligent assignment of SCDMA code sets and orthogonal codes used for interference separation in conjunction with other mutual interference reduction techniques such as signal polarization grouping, and spatial separation via directional antennas or beam-forming. More specifically, the present invention provides intelligent allocation of SCDMA orthogonal codes to terminals transmitting over a SCDMA uplink. This increases uplink capacity in the system by reducing the visible amount of interference originating from other terminals relative to the desired user's signal as received at the base station.

Intelligent allocation is accomplished in a number of combined ways. Two terminals with differing uplink signal polarizations may observe reduced mutual interference if polarized receive antennas are used at the base station. Terminals that are not adjacent to each other in a directional sense can be spatially separated via directional antennas or antenna beam forming. When mutual interference cannot be reduced via other means, SCDMA orthogonal codes may be used to reduce the amount of mutual interference generated by different terminals. However, the available number of SCDMA orthogonal codes is limited. As a result, intelligent allocation according to the present invention requires that there need not be assigned orthogonal codes from the same SCDMA code set within terminals where mutual interference can be separated via other means (e.g., polarization grouping or spatial separation). Accordingly, this advantageously increases the number of orthogonal separation codes available for interference reduction between terminals where interference cannot be reduced via other methods and thereby reduces the probability of code exhaustion within each SCDMA code set.

An important aspect of the present invention is to coordinate the assignment of SCDMA codes to terminals in an intelligent manner so that terminals, where mutual interference cannot be reduced via other methods (i.e., polarization grouping or spatial separation), are assigned to the same SCDMA code set to ensure orthogonality. Conversely, terminals where interference levels can be reduced via other methods can belong to different SCDMA code sets (which would not be orthogonal) because interference reduction can be achieved using the alternative approach. Accordingly, this intelligent allocation of the SCDMA code set by the scheduler reduces the overall amount of interference being generated and thus yields a related increase in uplink capacity.

### BRIEF DESCRIPTION OF THE DRAWINGS

FIG. 1 is a prior art diagram showing use of inner (i.e., OVSF) and outer (i.e., PN) codes in SCDMA to define SCDMA code sets.

FIG. 2 is a diagram showing relative reduction in average interference per user for polarization-based SCDMA code sets assignment algorithms according to the present invention as compared to random SCDMA code set assignment.

FIG. 3 is a diagram showing cell capacity as a percentage of the number of users who are synchronized.

FIG. 4 is a diagram showing use of inner and outer codes in SCDMA to define SCDMA code sets using polarization groupings in accordance with the present invention.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

The present invention includes an intelligent scheduling and code set assignment approach for a synchronous CDMA based uplink. As mentioned, SCDMA has been proposed for the uplinks of various third-generation evolution wireless systems in 3GPP and 3GPP2. The proposed SCDMA scheduling algorithm reduces observed interference and thus allows for a potentially significant increase in uplink capacity. This allows more terminals to be accommodated within a single site (i.e., higher sustainable user density) and/or a reduction in the number of base stations that must be deployed in order to cover a given area. This invention is applicable to any high-speed wireless evolution data system that would benefit from highly efficient and optimized scheduling algorithms.

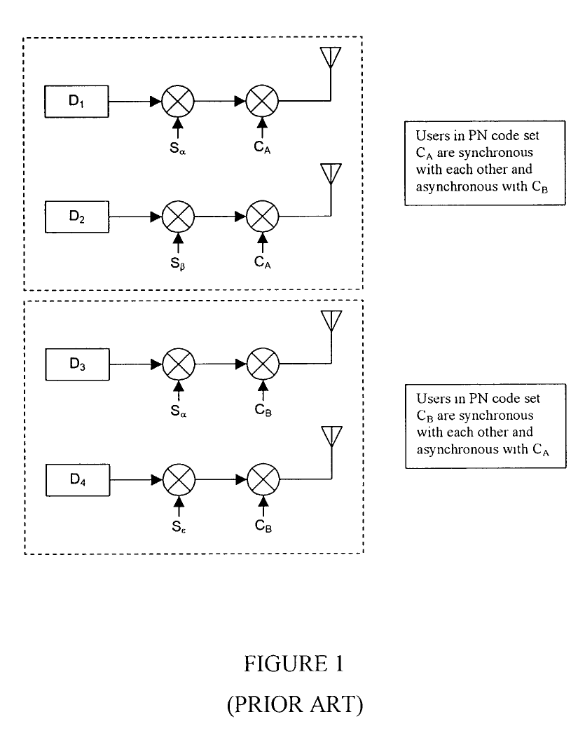

FIG. 1 shows a process with data streams from four sample users D₁, D₂, D₃, and D₄. Each data stream is spread by a respective OVSF code S_{α}, S_{β}, S_{α}, and S_{ε}. Each data stream is then further scrambled by a respective PN code C_{A}, C_{A}, C_{B}, and C_{B} before being transmitted. Stated otherwise, each user D₁, D₂, D₃, and D₄ represents a simultaneously active terminal that is assigned a respective OVSF spreading code and SCDMA code set combination (S_{α}, C_{A}), (S_{β}, C_{A}), (S_{α}, C_{B}), and (S_{ε}, C_{B}). Each of the users D₁ and D₂ share the same outer PN scrambling code C_{A} and are thus orthogonal (i.e., synchronous) to each other, but asynchronous to users D₃, and D₄ that share the outer PN scrambling code C_{B}. Similarly, users D₃, and D₄ belong to the same SCDMA code set. The same inner OVSF code may be reused within different SCDMA code sets. In this example, users D₁ and D₃ have been assigned the same OVSF spreading code S_{α}.

In polarization-based systems, typically two antennas with differing polarization orientations might be used at the receiver. For example, the antenna pair might represent horizontal and vertical polarizations. Consequently, the polarization vector of each user can be represented as a complex vector with two entries. Each of the two entries represents the complex value (magnitude and phase) of the received signal's polarization on the corresponding antenna element. Note that for simulation/evaluation purposes, these polarization vectors were generated by assigning a complex Gaussian value to each vector entry.

When polarization information is used at the receiver, an ideal matched polarization filter would be the complex conjugate of the desired user's polarization vector. The interference generated by another user would be represented by the projection of that second user's polarization vector onto the first user's polarization vector. If two users have similar polarizations, the mutual interference would be significant and could not be separated with a polarization-based approach. Conversely, if two users have “orthogonal” polarizations where the vector projections are zero or very small, the mutual interference would be minimal. In the former instance, the users would benefit from being assigned to the same SCDMA code set due to the ensuing reduction in mutual interference. In the latter instance, it is not essential to ensure that the two users are assigned to the same code set.

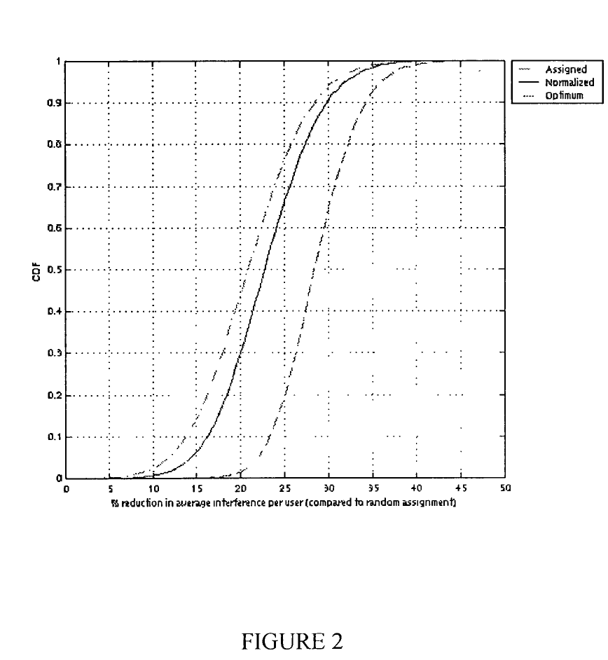

FIG. 2 shows sample interference reductions that can be obtained by using the polarization information to assign users to two (in this example) SCDMA code sets. The graph contains the observed cumulative distribution functions (CDFs) for the relative reductions in average interference per user as compared to a random SCDMA code set assignment. As an example, consider the solid line (Normalized) in FIG. 2. For a CDF of 0.1 (10%), the corresponding % reduction in interference is about 16%. This implies that 10% of all terminals experienced a reduction in interference of 16% or less. Conversely, 90% of all terminals experienced a reduction in interference of at least 16% (or more). FIG. 2 is just a simple method for presenting the statistics of the observed performance improvements. CDFs are often used instead of PDFs (probability distribution functions) since the CDF is the integral of the PDF and observation noise is thus less visible.

Three different code set algorithms, described in more detail hereinbelow, provide various yet significant interference reductions. The proposed algorithms have been shown via simulations to provide a 10-20% overall interference reduction with a 21-28% interference reduction at least half of the time. Interference for a specific user is calculated as the sum of all interfering (non SCDMA synchronized) polarization vector projections onto the desired user's polarization vector. Forty users were utilized to generate the performance graph shown in FIG. 2. However, use of the present invention has no negative impact on the performance of mobile terminals.

It should be understood that the polarization aspect of the present invention is more applicable to nomadic terminals where the received signal polarization will remain essentially constant over a long period of time, as opposed to mobile terminals where the received polarization will be random and will vary extremely rapidly with time.

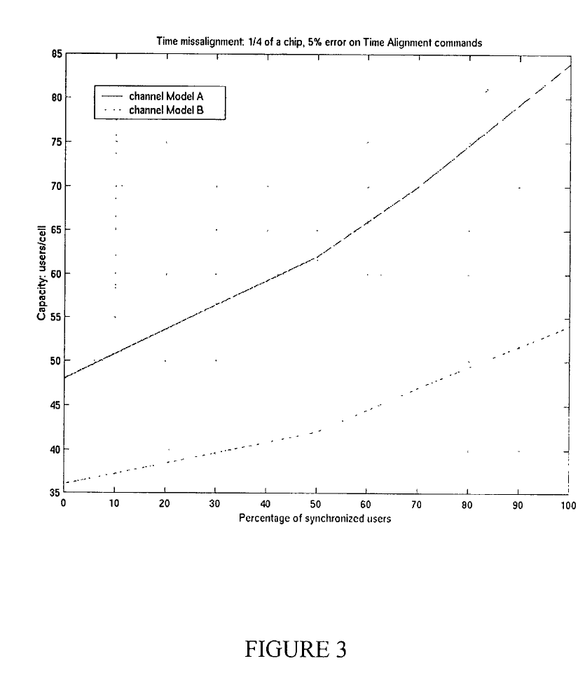

FIG. 3 provides a performance graph obtained from simulations that shows capacity as a function of the percentage of synchronized users for two different channel models. For purposes of simulation, it was assumed that a random SCDMA code set assignment with two code sets can be represented by the case where 50% of the users are synchronized with each other because the users are evenly distributed across the two SCDMA code sets. It was also assumed that an optimum SCDMA code set assignment could be represented by having 100% of the users be synchronized because all terminals within the same polarization group will belong to the same SCDMA code set. In reality, the 100% represents an upper bound on performance improvement for the present invention because the interference reduction due to polarization grouping will not be absolute due to the lack of complete orthogonality between different polarization directions. Thus, capacity using a non-intelligent SCDMA code set assignment scheme would be 62 and 42 users (for channels A and B, respectively), and application of the present invention would increase this to 84 and 54 users, correspondingly. This represents advantageous uplink capacity increases of 35% and 29%, respectively.

As shown in FIG. 1, a known approach for the assignment of OVSF codes to terminals would be to begin assigning OVSF codes from the first SCDMA code set until that code set is exhausted, and then begin a second SCDMA code set with a different PN outer code. However, this approach is likely to yield a random distribution of SCDMA code sets across different polarization groups. This non-intelligent (essentially random) assignment of SCDMA codes without taking into consideration whether or not the generated interference can be reduced via other methods has already been shown to produce higher interference levels than are necessary (see FIG. 2) which would likely result in a much smaller cell capacity. Using the present invention, uplink cell capacity can potentially be increased by 30-35% for the sample scenario considered here (see FIG. 3) and significant capacity increases can also be expected for other representative scenarios.

An important aspect of the present invention is that when assigning a new terminal to a specific SCDMA code set as is typically done in a scheduler, it is desirable to use the additional information about other methods of interference reduction that are available. There is no further gain to be obtained by assigning orthogonal OVSF interference reduction codes to different users when those users already only have a very small amount of visible mutual interference due to other interference reduction techniques such as polarization grouping.

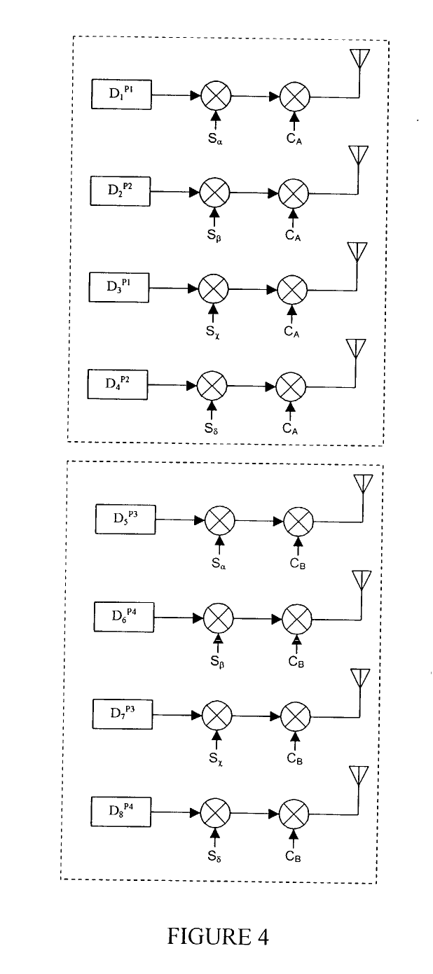

If the active terminals are to be divided into two or more different polarization groups with each group corresponding to a distinct SCDMA code set, this can be accomplished by classifying the user polarizations into different polarization groups based on the projections of their polarization vectors onto each other. Terminals with similar polarizations would be placed into the same polarization group and assigned orthogonal codes from within the same SCDMA code set, thus eliminating the mutual interference. Different polarization groups would be positioned such that the interference generated between distinct groups would be minimized. FIG. 4 shows a diagram similar to that shown in FIG. 1 except that the present invention has been utilized to create groupings of various user polarizations.

In FIG. 4, a process with data streams from eight sample users D₁^{P1}, D₂^{P2}, D₃^{P1}, D₄^{P2}, D₅^{P3}, D₆^{P4}, D₇^{P3}, and D₈^{P4} is shown. Users D₁^{P1} and D₃^{P1} have similar polarizations and are placed into the same polarization group denoted by the superscript P1. Other users are grouped similarly into remaining polarization groups P2 through P4. Polarization groups P1 and P2 are assumed to be non-orthogonal to each other, and P3 and P4 are also assumed to be non-orthogonal. However, polarization groups P1 and P2 are both orthogonal to both P3 and P4, and vice versa. Each data stream D₁^{P1}, D₂^{P2}, D₃^{P1}, D₄^{P2}, D₅^{P3}, D₆^{P4}, D₇^{P3}, and D₈^{P4} is spread by a respective OVSF code S_{α}, S_{β}, S₁₀₂, S_{□}, S_{α}, S_{□}, S_{χ}, and S_{δ}. Each data stream is then further scrambled by a respective PN code C_{A}, C_{A}, C_{A}, C_{A}, C_{B}, C_{B}, C_{B}, and C_{B} before being transmitted. Stated otherwise, each user D₁^{P1}, D₂^{P2}, D₃^{P1}, D₄ ^{P2}, D₅ ^{P3}, D₆^{P4}, D₇^{P3}, and D₈^{P4} represents a simultaneously active terminal each assigned a respective OVSF spreading code and SCDMA code set combination (S_{α}, C_{A}), (S_{β}, C_{A}), (S_{χ}) C_{A}), (S_{□}, C_{A}), (S_{α}, C_{B}), (S_{□}, C_{B}), (S_{χ}, C_{B}), and (S_{δ}, C_{B}).

With continued reference to FIG. 4, the users D₁^{P1} and D₃^{P1} share the same SCDMA code set (as defined by C_{A}) due to the fact that they also share the same polarization grouping P1 and are thus non-orthogonal to each other. Users D₂^{P2} and D₄^{P2} are also placed into the C_{A} code set since the polarization grouping P2 is non-orthogonal to P1. Hence, orthogonality between users must be obtained in this instance through the use of orthogonal spreading codes, and all four users (D₁^{P1}, D₂^{P2}, D₃^{P1}, D₄^{P2}) have been assigned to the same SCDMA code set. The remaining four users (D₅^{P3}, D₆^{P4}, D₇^{P3}, D₈^{P4}) are orthogonal to the first four users in a polarization sense since polarization groupings P3 and P4 have been assumed to be orthogonal to P1 and P2. Consequently, it is not necessary to achieve orthogonality via synchronous OVSF spreading codes, and the second set of four users may be assigned to a different SCDMA code set (C_{B}) as shown in FIG. 4. Note that the same OVSF spreading codes may be re-used within the two different SCDMA code sets. While polarization is illustrated, orthogonality may similarly be otherwise attained via orthogonal grouping based upon spatial diversity (e.g., via beam-forming, smart antennae, and the like).

Three projection-based classification techniques used within the present invention to classify the user polarizations are discussed below, in increasing order of algorithm complexity. The descriptions given here correspond to the illustrative case of only two SCDMA code sets, but could be easily expanded to an increasing number of code sets.

The first classification technique, referred to as axis assigning, uses an arbitrary pair of orthogonal axes, each of which corresponds to one of the two SCDMA code sets. Each user's polarization vector is projected onto both axes, and the magnitudes of these projections are calculated. The largest projection magnitude (representing the user who is closest to either of the two axes) is identified, and that user is assigned to the corresponding code set and removed from further consideration. This process is then repeated to identify the next user who is closest to one of the two axes. After half of the users (in this case) have been assigned to one of the two code sets, all remaining users are assigned to the other code set for a balanced assignment. The performance of the polarization-based axis assignment algorithm is shown by the dash-dot curve labelled “Assigned” in FIG. 2.

The second proposed algorithm, referred to as normalized assigning, is identical to the first technique, except that the users' polarization vectors are normalized to unit length before the axis projection takes place. This requires a slight increase in algorithm computational complexity, but also yields an increase of approximately 2% in the relative interference reduction. The performance of the polarization-based normalized assignment algorithm is shown by the solid line labelled “Normalized” in FIG. 2.

The third proposed classification approach, referred to as optimum assigning, is a more complex algorithm. Here, the normalized version of each user's polarization vector and the corresponding orthonormal vector are used in turn to define the pair of orthogonal projection axes. For each user-defined pair of axes, the previously discussed normalized polarization vector projection and SCDMA code set assignment process is conducted. This process is repeated for each set of user-defined projection axes, and the code set assignment that yields the lowest overall average interference per user is taken to be the optimum code set assignment. The performance of the polarization-based optimum assignment algorithm is shown by the dashed line labelled “Optimum” in FIG. 2. A clear improvement in performance over the other two assignment algorithms is visible, although at the cost of additional computational expense.

It should be readily understood that it is not always necessary to assign equal numbers of users to each SCDMA code set. In fact, because different users will likely be transmitting with different data rates, it may be desirable to assign different numbers of users to each SCDMA code set in order to equalize the aggregate throughput per code set.

To a less advantageous extent, the present invention is applicable when the ratio of SCDMA code sets to the number of degrees of freedom exceeds 1. This number of degrees is a quantity that represents the orthogonality factor that specifies the number of distinct “orthogonal” (actually semi-orthogonal in a polarization sense) sets.

Where appropriate, spatial separation (e.g., via direction antennas or antenna beam forming) can also be used as a basis for assigning individual users to different SCDMA code sets since their mutual interference will also be minimal in these situations.

It should be understood that the preferred embodiments mentioned here are merely illustrative of the present invention. Numerous variations in design and use of the present invention may be contemplated in view of the following claims without straying from the intended scope and field of the invention herein disclosed.

Having thus described the invention, what is claimed as new and secured by Letters Patent is:

1. A method for uplink SCDMA scheduling within a telecommunications system capable of separating users, said method comprising:
a) determining a characteristic of a first user;
b) determining a related characteristic of a second user;
c) comparing said characteristic to said related characteristic to verify orthogonality therebetween;
d) upon determination of orthogonality, assigning said first user and said second user differing SCDMA code sets;
e) upon determination of non-orthogonality, assigning said first user and said second user an identical SCDMA code set.

2. The method as claimed in claim 1, wherein said characteristic and said related characteristic are polarization information.

3. The method as claimed in claim 1, wherein said characteristic and said related characteristic are spatial information.

4. The method as claimed in claim 2, wherein said determining steps further includes
f) providing an arbitrary pair of orthogonal axes, each of which corresponds to one of two SCDMA code sets,
g) projecting a polarization vector of both said first user and said second user onto said pair of orthogonal axes,
h) calculating magnitudes of said polarization vectors,
i) identifying a larger one of said magnitudes,
j) assigning said first user or second user related to said larger one of said magnitudes to one of said two SCDMA code sets corresponding to one of said pair of orthogonal axes closest to said larger one of said magnitudes,
k) removing from further consideration the other of said first user or second user not related to said larger one of said magnitudes,
l) repeating step f) through step k) so as to identify another user closest to one of said pair of orthogonal axes until half of all users have been assigned to one of said two SCDMA code sets,
m) assigning all remaining users to the other one of said two SCDMA code sets.

5. The method as claimed in claim 2, wherein said determining steps further includes
f) providing an arbitrary pair of orthogonal axes, each of which corresponds to one of two SCDMA code sets,
g) normalizing a polarization vector of both said first user and said second user to unit length,
h) projecting a polarization vector of both said first user and said second user onto said pair of orthogonal axes,
i) calculating magnitudes of said polarization vectors,
j) identifying a larger one of said magnitudes,
k) assigning said first user or second user related to said larger one of said magnitudes to one of said two SCDMA code sets corresponding to one of said pair of orthogonal axes closest to said larger one of said magnitudes,
l) removing from further consideration the other of said first user or second user not related to said larger one of said magnitudes,
m) repeating step f) through step l) so as to identify another user closest to one of said pair of orthogonal axes until half of all users have been assigned to one of said two SCDMA code sets,
n) assigning all remaining users to the other one of said two SCDMA code sets.

6. The method as claimed in claim 2, wherein said determining steps further includes
f) normalizing a polarization vector of both said first user and said second user to unit length,
g) providing a pair of orthogonal axes defined by said polarization vectors of both said first user and said second user and orthonormal vectors corresponding to said polarization vectors, each said pair of orthogonal axes corresponding to one of two SCDMA code sets,
h) projecting a polarization vector of both said first user and said second user onto said pair of orthogonal axes,
i) calculating magnitudes of said polarization vectors,
j) identifying a larger one of said magnitudes,
k) assigning said first user or second user related to said larger one of said magnitudes to one of said two SCDMA code sets corresponding to one of said pair of orthogonal axes closest to said larger one of said magnitudes,
l) removing from further consideration the other of said first user or second user not related to said larger one of said magnitudes,
m) repeating step f) through step l) so as to identify another user closest to one of said pair of orthogonal axes until an optimum code set assignment that yields a lowest overall average interference per user is determined.

7. The method as claimed in claim 2, wherein said determining steps further includes
f) providing more than two substantially orthogonal axes, each of which corresponds to an SCDMA code set,
g) projecting a polarization vector of both said first user and said second user onto said more than two substantially orthogonal axes,
h) calculating magnitudes of said polarization vectors,
i) identifying a larger one of said magnitudes,
j) assigning said first user or second user related to said larger one of said magnitudes to one of said SCDMA code sets corresponding to one of said more than two substantially orthogonal axes closest to said larger one of said magnitudes,
k) removing from further consideration the other of said first user or second user not related to said larger one of said magnitudes,
l) repeating step f) through step k) so as to identify another user closest to one of said more than two substantially orthogonal axes until half of all users have been assigned to one of said SCDMA code sets,
m) assigning all remaining users to another one of said SCDMA code sets.

8. The method as claimed in claim 2, wherein said determining steps further includes
f) providing more than two substantially orthogonal axes, each of which corresponds to an SCDMA code set,
g) normalizing a polarization vector of both said first user and said second user to unit length,
h) projecting a polarization vector of both said first user and said second user onto said more than two substantially orthogonal axes,
i) calculating magnitudes of said polarization vectors,
j) identifying a larger one of said magnitudes,
k) assigning said first user or second user related to said larger one of said magnitudes to one of said SCDMA code sets corresponding to one of said more than two substantially orthogonal axes closest to said larger one of said magnitudes,
l) removing from further consideration the other of said first user or second user not related to said larger one of said magnitudes,
m) repeating step f) through step l) so as to identify another user closest to one of said pair of orthogonal axes until half of all users have been assigned to one of said SCDMA code sets,
n) assigning all remaining users to another one of said SCDMA code sets.

9. The method as claimed in claim 2, wherein said determining steps further includes
f) normalizing a polarization vector of both said first user and said second user to unit length,
g) providing more than two substantially orthogonal axes defined by said polarization vectors of both said first user and said second user and orthonormal vectors corresponding to said polarization vectors, each said more than two substantially orthogonal axes corresponding to an SCDMA code set,
h) projecting a polarization vector of both said first user and said second user onto said more than two substantially orthogonal axes,
i) calculating magnitudes of said polarization vectors,
j) identifying a larger one of said magnitudes,
k) assigning said first user or second user related to said larger one of said magnitudes to one of said SCDMA code sets corresponding to one of said more than two substantially orthogonal axes closest to said larger one of said magnitudes,
l) removing from further consideration the other of said first user or second user not related to said larger one of said magnitudes,
m) repeating step f) through step l) so as to identify another user closest to one of said more than two substantially orthogonal axes until an optimum code set assignment that yields a lowest overall average interference per user is determined.
